(19) United States
(12) Patent Application Publication
(10) Pub. No.: US 2011/0159175 A1
(43) Pub. Date: Jun. 30, 2011

(54) METHODS FOR INHIBITING CORROSION OF HIGH STRENGTH STEEL TURBINE COMPONENTS

(76) Inventors: Jon Raymond GROH, Loveland, OH (US); Thomas Allen Kauffung, West Chester, OH (US); Mark Alan Rhoads, Cincinnati, OH (US)

(21) Appl. No.: 12/649,737

(22) Filed: Dec. 30, 2009

(51) Int. Cl. B05D 1/36; B05D 1/02; B05D 5/00; B05D 1/18; B05D 1/28

(52) U.S. Cl. 427/142; 427/402; 427/405; 427/247; 427/419.1; 427/419.2

(57) ABSTRACT

Disclosed herein is a method for inhibiting corrosion of a high strength steel turbine component subject to rotary stress. The method comprises applying a sacrificial overlay coating material to at least a portion of a surface of the component to form a protected component, and applying a seal material to at least a portion of the protected component to form a seal coat having a temperature resistance of greater than about 500° F. Also disclosed herein is a turbine component and corresponding engine protected by the method. Further provided is a method for repairing a high strength steel component of a turbofan engine. These methods are capable of inhibiting at least one of stress corrosion cracking or surface pitting of the turbine component after exposure to corrosive water.

### FIELD OF THE INVENTION

The present invention generally relates to methods for inhibiting corrosion of turbine components. In particular, some embodiments herein relate to methods for inhibiting corrosion of high strength steel turbine components which are subjected to rotary stress in operation.

### BACKGROUND

Turbine engines, especially aviation gas turbine engines, have been increasingly moving towards higher power and higher performance designs in order to accommodate market needs. As a result, many turbine components are subjected to severe stresses at times, in order to satisfy such designs. For critical rotating components and engine mounts in such gas turbine engines, ferrous materials of excellent toughness are often preferred. In particular, high strength steels, typified by maraging steels, are often used for such components. Maraging steels are generally nickel-containing iron-base alloys of extremely high strength, typically produced from martensite steel by spontaneous hardening at moderate temperatures without quenching. Such high strength steels are often used in applications in which structural components are subjected to torsional fatigue, such as fan shafts which couple a turbine to a fan of a turbine engine.

However, high strength steels can sometimes fall prone to prone to corrosive attack such as stress corrosion cracking. Therefore, coatings have been developed to help protect against environmental attack. Overlay coatings which confer a sacrificial galvanic property to turbine components have been preferred. One popular type of coating employs water-based slurries containing an aluminum-based dispersion in an acidic solution, containing anions such as phosphates and chromates. Upon exposure to heat and curing, these slurries can transform to an insoluble electrically conductive metal/ceramic composite. These sacrificial coatings are exemplified in commercial products such as SermeTel® W (manufactured by Sermatech International Inc., Limerick, Pa.) and as described in U.S. Pat. No. 3,248,251.

It remains desirable to develop and implement improved coating systems for turbine components.

### BRIEF SUMMARY OF THE INVENTION

One embodiment of the present invention is directed to method for inhibiting stress corrosion cracking or surface pitting of a turbine component subject to rotary stress. The method comprises, providing a turbine component comprising a high strength steel; applying a sacrificial overlay coating material to at least a portion of a surface of the component to form a protected component; and, applying a seal material to at least a portion of the protected component to form a seal coat having a temperature resistance of greater than about 500° F. The noted method is capable of inhibiting at least one of stress corrosion cracking or surface pitting of the turbine component after exposure to corrosive water.

A further embodiment of the present invention is directed to a method for inhibiting stress corrosion cracking or surface pitting of a fan mid shaft section of a gas turbine engine. This method comprises, providing a turbine component comprising high strength steel having a yield strength of at least about 1380 MPa, wherein the turbine component is a fan mid shaft coupled in a turbofan engine; applying a sacrificial overlay coating material to at least a portion of a surface of the component to form a protected component; and applying a seal material to at least a portion of the protected component to penetrate seal material into at least some pores of the protected component and form a seal coat having a temperature resistance of greater than about 500° F. This noted method is capable of inhibiting at least one of stress corrosion cracking or surface pitting of the fan mid shaft after exposure to corrosive water.

A yet further embodiment of the present invention is directed to a method for repairing a high-strength steel component of a turbofan engine. This method comprises, inspecting the component; applying a sacrificial overlay coating material to at least a portion of a surface of the component to form a protected component; and applying a seal material to at least a portion of the protected component to form a seal coat having a temperature resistance of greater than about 500° F. Such method is capable of inhibiting at least one of stress corrosion cracking or surface pitting of the component after exposure to corrosive water.

Other features and advantages of this invention will be better appreciated from the following detailed description.

### BRIEF DESCRIPTION OF THE DRAWINGS

Embodiments of the invention will now be described in greater detail with reference to the accompanying Figures.

FIG. 1 is a photograph of an array of high strength steel coupon samples undergoing a two point bend corrosion test.

FIG. 2A is a photograph of the array of high strength steel coupon samples undergoing a two point bend corrosion test after 15 day exposure to synthetic seasalt solution.

FIG. 2B is a photograph of the array of high strength steel coupon samples undergoing a two point bend corrosion test after 46 day exposure to synthetic seasalt solution.

FIG. 3 is a microphotogram of a high strength steel substrate coated according to an embodiment of the invention.

### DETAILED DESCRIPTION

In accordance with embodiments, the present invention generally relates to methods for inhibiting corrosion of high strength steel turbine components which are subjected to rotary stress in operation. In general, such methods comprise a step of providing a turbine component comprising a high strength steel. As used herein, the term “high strength steel” also encompasses ultra-high strength steels, and will generally refer to steels having a yield strength of at least about 1380 MPa (ca. 200 ksi). A ksi refers to 1000 pounds per square inch pressure. More particularly, such steels will have a yield strength of at least about 1725 MPa (ca. 250 ksi) or at least about 2070 MPa (ca. 300 ksi). In many embodiments, turbine components of the present disclosure comprises a high strength steel having a yield strength of between about 2070 MPa (ca. 300 ksi) and about 2484 MPa (ca. 360 ksi).

Useful steels according to embodiments may comprise one or more maraging steel. Sonic typical examples of high strength steels according to embodiments include a steel selected from Marage 250, GE1014, and GE 1010, AERMET® 100, AERMET® 310, and AERMET® 340 (AERMET is trademark of Carpenter Technology Corporation); or the like.

Generally, the turbine component may be coupled in a gas turbine engine. Suitable gas turbine engines may include single-spool gas turbine engine, two-spool gas turbine engine, multi-spool gas turbine engine, FLADE engine, variable cycle gas turbine engine, or adaptive cycle gas turbine engine; or the like. For example, the gas turbine engine may be an aviation turbofan engine such as the GE90 series or the GEnx series engine available from General Electric Company, Cincinnati, Ohio.

In one embodiment, the turbine component comprises a shaft. A shaft may be defined as having a first end, an opposing second end, and a tubular portion extending between the ends. At least the tubular portion of a shaft may comprise or be made substantially entirely of a high strength steel. In embodiments where the turbine component is a shaft, it may be coupled in a gas turbine engine such as a high bypass gas turbine engine or turbofan. For example, a subject shaft to which methods of the present disclosure may be applied, may be the fan mid shaft component of a shaft assembly, wherein such shaft assembly extends between a fan assembly of the gas turbine engine and a low pressure turbine (LPT) of the engine for the purpose of transmission of torque between the fan and the LPT during operation. Typically, the fan mid shaft mates to a fan forward shaft, for example, through splines. Applicants have found that a fan mid shaft in operation may encounter temperatures of up to about 700° F. on the outside of the shaft and about 500° F. on the inside, conditions which can exacerbate stress corrosion cracking when in the presence of corrosive water. In other embodiments of the present invention, the subject turbine component may comprise a coupling nut, in particular, a coupling nut which connects a fan mid shaft of a gas turbine engine with a fan forward shaft of the engine.

Therefore, methods according to embodiments of the present invention comprise at least a step of applying a sacrificial overlay coating material to at least a portion of a surface of the turbine component. Some embodiments comprise at least a step of applying a sacrificial overlay coating material to substantially all of a surface of the turbine component. Generally, a sacrificial overlay coating material may include metallic particles of a metal (or metal alloy) which is more active than iron in the electromotive force series. In certain embodiments, such metallic particles may include of one or more selected from the group consisting of aluminum, zinc, cadmium, magnesium, and alloys of any of the foregoing metal; or the like. In particularly preferred embodiments, metallic particles of the sacrificial overlay coating material may comprise aluminum. Typically, a step of applying a sacrificial overlay coating material to a turbine component includes a step of applying a slurry which comprises the metallic particles, suspending or otherwise contained in a liquid vehicle, often aqueous. The sacrificial overlay coating material may also comprise an aqueous solution or slurry of at least one of phosphate, molybdate, vanadate, tungstate, or chromate (or the like), such as a metal (e.g., alkali metal) salt of the foregoing.

The basic sacrificial overlay coating material of this type has been described in U.S. Pat. No. 3,248,251 (Allen). Commercial examples of such a material include Alseal® 500 and 518 manufactured, by Coatings for Industry (Souderton, Pa., ScrmcTel® W and 962 manufactured by Sermatech International Inc. (Limerick, Pa.). Coating compositions of this type containing hexavalent chromium and phosphate are described in U.S. Pat. Nos. 3,248,249; and 3,248,250.

If necessary or desired, (as in for example, a repair method), the turbine component may be mechanically worked prior to application of the sacrificial overlay coating material, for example, to remove damage or to smooth the surface of the turbine component. Generally, the sacrificial overlay coating material is applied to the turbine component by any applicable method, such as spraying, brushing, rolling or dipping; or the like. An electrostatic gun or the like may also be suitable for this purpose.

The step of applying a sacrificial overlay coating material may occurs in one or more (often two) coating steps. In certain embodiment, the specific application method is usually chosen so as to be effective to form a sacrificial coat (after drying and curing, as outlined below) having total thickness of from about 5 micrometers (ca. 0.2 mils) to about 101 micrometers (ca. 4 mils), or more specifically, from about 25 micrometers (ca. 1 mils) to about 51 micrometers (ca. 2 mils). In certain embodiment, the specific application method is usually chosen so as to be effective to form a sacrificial coat (after drying and curing) having a substantially uniform thickness. In many embodiments, the final sacrificial coat will be a substantially electrically conductive coat, in order to effect its galvanic protection.

As noted, after an initial application of a sacrificial overlay coating material to a turbine component, it may be dried to substantially remove any liquid vehicle of the material. In some embodiments, this drying may comprise, for example, air drying for a period (e.g., greater than 15 minutes) and at a temperature (e.g., from about 150° F. to a about 200° F.). After drying, the sacrificial overlay coating material may be cured at a temperature of, for example, from about 500° F. to about 1112° F. (ca. 260° C. to ca. 600° C.), or more narrowly, from about 572° F. to about 1067° F. (ca. 300° C. to ca. 575° C.). If more than one application step is employed, then drying and/or curing may be conducted after each application.

The step of applying a sacrificial overlay coating material to at least a portion of a turbine component comprising high strength steel, followed by its drying and curing, may be said to provide a “protected” component. However, in accordance with embodiments of the invention, the method for inhibiting stress corrosion cracking of a turbine component subject to rotary stress further comprises applying a seal material to at least a portion (or, to at least substantially all) of the protected component, to form a seal coat having a temperature resistance of greater than about 500° F. That is, the seal material after it has been applied and formed into a seal coat (e.g., after its drying and/or curing) has a resistance to temperatures of greater than about 500° F., or in some embodiments, greater than about 700° F. or greater than about 750° F. In certain embodiments, it is desirable for a seal coat to be resistant to a temperature of greater than about 700° F. for at least about 1000 h of operation. A seal coat having a temperature resistance of less than 500° F. is not suitable for embodiments of the present invention.

Importantly, applicants of the present invention have found that a turbine component protected solely by a sacrificial coating may comprise pores or “wormholes”, tortuous paths which can permit corrosive forms of water to penetrate the sacrificial coat, and which may contribute, if not mitigated, to mechanisms that promote corrosion. Therefore, the application of a seal material should be conducted in such a manner that seal material penetrates into at least some of the pores of the protected component. In some embodiments, a non-porous seal coat is formed.

Optionally, intermediate steps may be performed upon the protected component prior to application of the seal material. Thus, the method according to embodiments of the invention may further include at least one step of mechanically working the protected component prior to applying the seal material. Such step of mechanically working may include burnishing the sacrificial coat, or crushing or peening particles. However, it has been found advantageous in certain embodiments to not perform a step of burnishing the sacrificial coat prior to application of the seal material. Without being limited by theory, it is believed that by not performing a burnishing step, the seal material may be better able to penetrate and form a non-porous seal coat which protects the underlying high strength steel. Other primers and/or types of coating materials may optionally be provided on the protected component prior to application of seal material; however, in many embodiments the seal material is applied directly to the protected component without any intervening material.

Generally, a seal material is chosen provided that it has the requisite temperature resistance, and can penetrates into at least some of the pores of the protected component to inhibit stress corrosion cracking (SCC) or surface pitting of the turbine component. Seal materials are typically chosen so that the final seal coat does not delaminate. Generally, it is also important that seal materials not be brittle, in order to withstand the application of the stresses endured by critical rotating components of gas turbine engines. Many suitable seal materials may comprise one or more of a polymeric material or a ceramic material; or the like. Typically, a seal material according to embodiments of the invention may comprise at least a binder and a pigment, usually carried in a liquid vehicle such as water or volatile organic liquid. In certain embodiments one or both of the seal material and the sacrificial overlay coating material may be substantially free of chromium, e.g., hexavalent chromium. Some binder substances which have been found to be suitable for use as components of a seal material include one or more of a silicone, silicon, a phosphate or a fluorinated polymer; or the like. In certain embodiments, a suitable silicone binder may be selected from one or more of polydimethylsiloxane, silicone alkyd, silicone epoxy, or a silicone polyester; or the like. In certain other embodiments, a suitable phosphate binder may be selected from one or more of phosphoric acid or a phosphate of potassium, aluminum, ammonium, beryllium, calcium, iron, lanthanum, lithium, magnesium, sodium, yttrium, zinc, zirconium, or combinations thereof. In yet other embodiments, a suitable fluorinated polymer binder may include a polytetrafluoroethylene (PTFE).

Some pigment substances which have been found to be suitable for use as components of a seal material, include one or more of metallic particles (e.g., aluminum particles), spinels, carbon particles, silica, siliceous materials, metal silicates, metal hydroxides, and metal oxides; or the like. In certain embodiments, the pigment may comprise one or more of metal hydroxides and metal oxides selected from oxides and hydroxides of magnesium, aluminum, iron, chromium, sodium, zirconium and calcium and combinations thereof; or the like. The use of the term “pigment” does not necessarily imply that the substance is of a particular color, but it may be desirable for it to be generally insoluble in a liquid vehicle, of the seal material.

Seal material may be applied to at least a portion of a protected component by any effective means for the utility, such as an application method selected from the group consisting of brushing, rolling, dipping, injecting, spraying, spin-coating, flow-coating, knife-coating, sprinkling, and combinations thereof; or the like. Often, seal material is applied in a single coat, or more than one coat. Typically, sufficient material may be applied so as to form a seal coat (after any drying and/or curing) having thickness of from about 2 micrometers (ca. 0.1 mils) to about 50 micrometers (ca. 2 mils). Generally, any applied coat of seal material (whether applied in one step, or in more than one step) may be dried to remove any liquid vehicle, and then may be cured under conditions effective to form a substantially non-porous and/or non-electrically-conducting seal coat. Such conditions may include a temperature anywhere in the range of from about 300° F. to about 700° F. (more narrowly, in the range of from about 300° F. to about 500° F.), for a time period of, for example, from 0.1 h to about 10 h (more narrowly, from about 0.5 h to about 2 h).

Suitable combinations of sacrificial overlay coating materials and seal materials are shown in Table I below. Any one or more of the sacrificial overlay coating materials shown in Table I may be used with any one or more of the seal coat materials shown in this Table. Many of these materials are commercially available, and the source of the materials is shown as indicated. Many of these products are known by their trade names and are capitalized or marked, as appropriate. A general description is also provided, but should not be taken as a limitation of the invention.

TABLE 1

| | General description |
|---|---|
| Sacrificial Overlay Coating Material | |
| Praxair Surface Technologies, Inc, | Protective coating usually comprising |
| (Sermatech) SERMETEL ® W | dissolved phosphate, dissolved |
| | chromate, solid particulate aluminum |
| Praxair Surface Technologies, Inc, | Chromate-free aluminum sacrificial |
| (Sermatech) CF 1768 Version | coat |
| Indestructible Paint, Ltd. | Sacrificial basecoat usually comprising |
| IPCOTE ® 9183 | dissolved Cr³⁺, phosphate, and powder |
| | of Al |
| CeralUSA, Inc. CERAL ® 34 | Aluminum filled polyphosphate base coat |
| Coatings for Industry, | Protective coating usually comprising |
| Inc. ALSEAL ® 5000 | dissolved phosphate, dissolved |
| | chromate, solid particulate aluminum |
| Seal Material | |
| Valspar, Inc. PLASTI-KOTE ® HP-12 | Hot paint, white |
| Praxair Surface Technologies, | 1083 is a primer of a polymer resin |
| Inc, (Sermatech) SERMETEL ® | mixture, aluminum metal powder, |
| 1083/1140 | strontium chromate. 1140 comprises a |
| | polymer resin mixture, titanium |
| | dioxide, and polytetrafluoroethylene. |
| Praxair Surface Technologies, | PTFE-containing primer + topcoat |
| Inc, (Sermatech) 1207/1210 | system. |
| Indestructible Paint, Ltd. IP9184 Khaki | High temperature inorganic sealing coating. |
| Indestructible Paint, Ltd. IP1949 | Chrome free, heat and corrosion |
| Organic Sealcoat | resistant organic sealcoat to give a very |
| | fine surface finish. |
| Indestructible Paint, Ltd. 9286-1140 | Fluoropolymer low friction coating. |
| Indestructible Paint, Ltd. | A high temperature, lead free, spraying |
| IPCOTE ® 9029R2 | aluminum enamel |
| Indestructible Paint, Ltd. | A smooth surface, low chromium coating with |
| IPCOTE ® IP9442 smoothcoat | small particle size aluminum powder |
| NIC Industries, Inc. | A High-Temperature Ceramic Coating |
| CERAKOTE ® V169 | |
| NIC Industries, Inc. | A High-Temperature Ceramic Coating |
| CERAKOTE ® V171 | |
| Dampney Company, Inc. | Silicone based high heat resistant paint |
| THURMALOX ® 231 | |
| POR-15 Inc. (Morristown, NJ) | Aluminum containing silicone alkyd |
| POR-20 ® Silicon Paint | high temperature paint |
| CeralUSA, Inc., CERAL ® 50 | A chemically inert and chrome-free top coat |

Some effective combinations of sacrificial overlay coating materials and seal materials are shown in Table II. In some cases, more than two types of materials can be employed, as for instance, in the use of Ipcote IP9183-R1 used with IP9442 and Ipscal 9184 khaki. These products are available from Indestructible Paint, Ltd., Birmingham, UK.

TABLE II

Ipcote IP9183-R1 + Burnish + IP9442 + Ipscal 9184 khaki
SermeTel W + Sermatech 1083/1140
Ipcote IP9442 Smoothcote + Ipeal 9184 khaki
Ipcote IP9183-R1 burnished + Ipseal 9183 khaki
Ipcote IP9183-R1 + Ipseal 9184 khaki

Methods in accordance with embodiments of the invention may be capable of inhibiting stress corrosion cracking (SCC) and/or surface pitting of the turbine component under a wide variety of conditions. One type of SCC which may be inhibited includes stress-accelerated grain boundary oxidation (SAGBO). Turbine components comprising high strength steel may be subject to SCC even at room temperature (as well as at higher temperatures), especially in the presence of corrosive water. As the term is used herein, “corrosive water” may refer to water which comprises salt (e.g., sea salt) or acid (e.g., a carboxylic acid). Applicants have found that a fog or mist of aqueous sea salt can promote such aggressive corrosion. Furthermore, applicants have also found that aged or used lubricating oils can form rancid oils containing carboxylic acids which, in combination with water, can also be detrimental.

Although certain prior art processes have employed sacrificial overlay coatings for turbine components comprising high strength steel, these processes have been found by the present applicants to be not reliable for certain applications, especially for critical components subject to rotary stress and high temperatures. Despite the presence of a sacrificial coating on such components, unacceptable levels of cracking, flaking and spalling could nevertheless occur. Therefore, applicants have developed the methods of the present disclosure, in order to mitigate intrusion of rancid oils and/or corrosive water.

In accordance with another embodiment of the invention, herein is also provided a turbofan engine comprising: fan, compressor, combustor, high pressure turbine, and a lower pressure turbine, all in fluid flow communication. The fan and the lower pressure turbine are operatively coupled by a first shaft assembly, and the compressor and the high pressure turbine are operatively coupled by a second shaft assembly. At least the first shaft assembly includes a turbine component, which is composed of: (1) a turbine component substrate comprising a high strength steel, as described above, (2) a sacrificial coat overlaying at least a portion of the substrate, as described above, and (3) a seal coat having a temperature resistance of greater than about 500° F., as described above, over at least a portion of the sacrificial coating. The turbine component of the first shaft assembly is thus resistant to stress corrosion cracking and/or surface pitting of the substrate after exposure to corrosive water.

Generally, the turbofan engine may be a multispool engine, and the lower pressure turbine may be an intermediate pressure turbine or a low pressure turbine. The component of the first shaft assembly may be a fan mid shaft, or may be a coupling nut.

In accordance with a further embodiment of the present invention, a method for repairing a high-strength steel component of a turbofan engine is provided. The component can be any of the named turbine components described above, and the nature of the high strength steel can also be similarly as described above. This method generally comprises an initial step of inspecting the component. Inspection may be visual, directed at locating the existence of cracking, flaking, spalling or pitting, or other visible indicia of corrosion. Or, inspection may comprise one or more inspection step selected from eddy current inspection, etching, visual inspection, magnetic particle inspection, hardness checking, dye penetration inspection, or ultrasound inspection; or the like.

Generally, a repair method may subsequently comprise a step of removing a damaged portion from a surface of the component. In some embodiments, a previously applied sacrificial coating may be present on the surface of the component, which may be present on the component as originally manufactured, or from a previous repair or protection process. Some or all of this previously applied sacrificial coating may be removed, in order to provide a suitable surface. Appropriate machining may be involved in order to remove any damage or any previous coating, such as sanding, blasting, smoothing, grinding, or the like.

A repair method according to embodiments of the invention further comprises applying a sacrificial overlay coating material to at least a portion of a surface of the component to form a protected component; and applying a seal material to at least a portion of the protected component to form a seal coat having a temperature resistance of greater than about 500° F. These materials and processes, and their resulting technical effect, are as described in detail above.

In order to promote a further understanding of the invention, the following examples are provided. These examples are illustrative, and should not be construed to be any sort of limitation on the scope of the claimed invention.

### Example

The corrosion resistance of many combinations of sacrificial overlay coating materials and seal materials were evaluated by exposing stressed high strength steel coupons to synthetic sea salt fog. A two point bend test was performed on high strength steel coupons coated with various systems. Each sample tested is shown in Table III. The sacrificial coatings were applied using standard paint spray equipment after grit blasting and cleaning of the surface. These coats were applied in two layers, with each layer 1 mil thick. The seal coats were applied in two layers, with a cure cycle of 400° F. for 1 hour in air, after application of each layer. The seal coat was applied at 0.3-1 mil by standard paint methods.

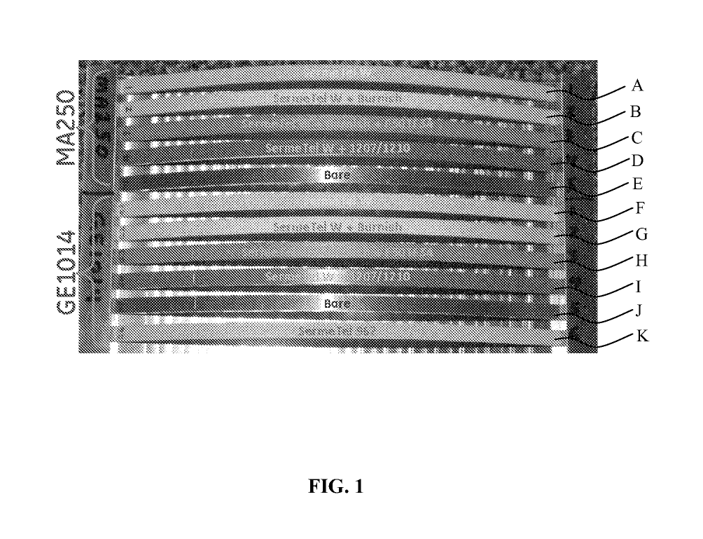

The test coupons were long rectangular strips of steel, stressed by bending at two points. The amount of applied stress was 161 ksi (ca. 1100 MPa) maximum bend stress, chosen since it is about double the typical engine part stress load. The sea salt fog test was performed by first formulating a synthetic sea salt solution having 4% by weight salt. Testing of each coupon in a stressed position was performed at room temperature in a closed container, with 3 inches of water in the bottom. The humidity inside the closed container was 100%. Test specimens were held above water for 8 hours and then submersed for 16 hours a day. FIG. 1 shows eleven sample coupons, A-K, as held in place in stress position in the sample holder: The base steel for A-E was Marage 250, whereas the base for F-K was GE1014. Table III shows the composition of the coated samples.

TABLE III

| | | | Current | Time to | Surface corrosion |
|---|---|---|---|---|---|
| | Substrate | | Running | Failure | observed after |
| Sample | Alloy type | Coating type | Time (days) | (days) | testing? |
| A | Marage 250 | SermeTel W only | 235.94 | did not | Yes |
| | | | | fail yet | |
| B | Marage 250 | SermeTel W only + | fail | 48.7 | Yes |
| | | burnishing | | | |
| C | Marage 250 | SermeTel W + F50TF34 | fail | 46.7 | Yes |
| D | Marage 250 | SermeTel W + 1207/1210 | 235.94 | did not | No |
| | | | | fail yet | |
| E | Marage 250 | Bare | fail | 33.7 | Yes |
| F | GE1014 | SermeTel W only | fail | 42 | Yes |
| G | GE1014 | SermeTel W only + | fail | 158.7 | Yes |
| | | burnishing | | | |
| H | GE1014 | SermeTel W + F50TF34 | fail | 46.7 | Yes |
| I | GE1014 | SermeTel W + 1207/1210 | 235.94 | did not | No |
| | | | | fail yet | |
| J | GE1014 | Bare | fail | 18.7 | Yes |
| K | GE1014 | SermeTel 962 only | fail | 62.7 | Yes |

SermeTel 962 is aluminum-filled chromate/phosphate ceramic slurry, available from Praxair Surface Technologies, Inc, (Sermatech). F50TF34 refers to a coating system used by General Electric Company, which is a two part system having a sacrificial aluminum-containing coat applied as a slurry, to which a ceramic overcoat is applied.

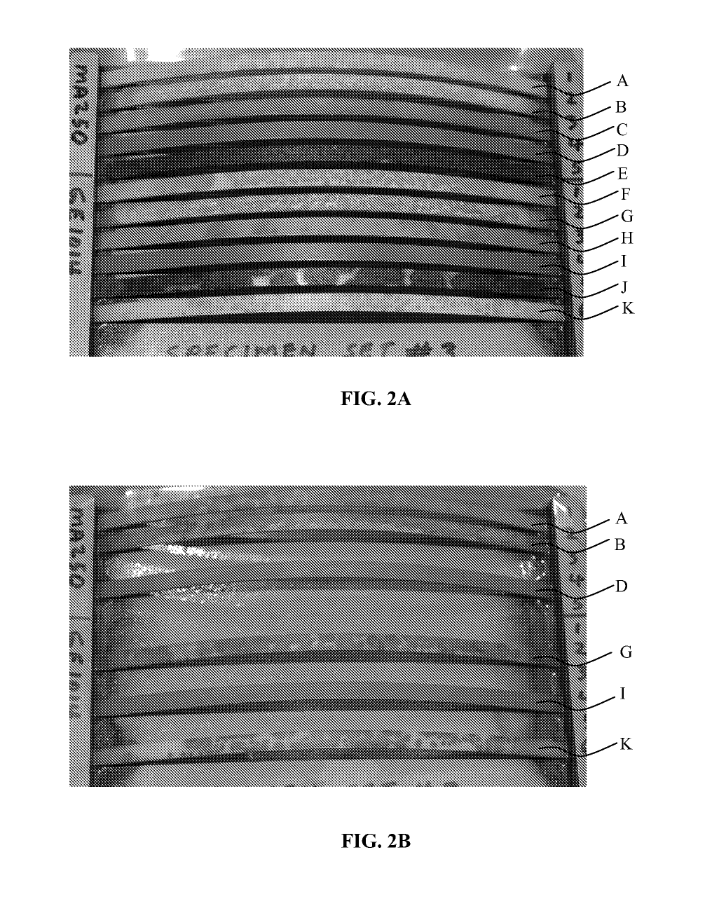

The ultimate failure of a stressed rectangular coupon was determined by whether it remained in place in its stressed position, or whether it had cracked or snapped to such an extent that it no longer remained present in its holder. FIG. 2A shows the specimens after 15 days exposure to the synthetic sea salt at room temperature. Marked pitting and visible corrosion is especially evident in all samples except Samples D and I. FIG. 2B shows dramatic changes in Samples C, E, F, H, and J. Whereas in FIG. 1, all samples are seen as present in their holder, in FIG. 2B, after 46 days of testing exposed to sea salt fog, samples C, E, F, H, and J are completely absent, having been cracked or snapped due to extensive corrosion. The only samples which reliably did not exhibit surface corrosion and which remained in the sample holder, were exemplary high strength steel coupons coated with both a sacrificial overlay coating material and a seal material according to the present disclosure.

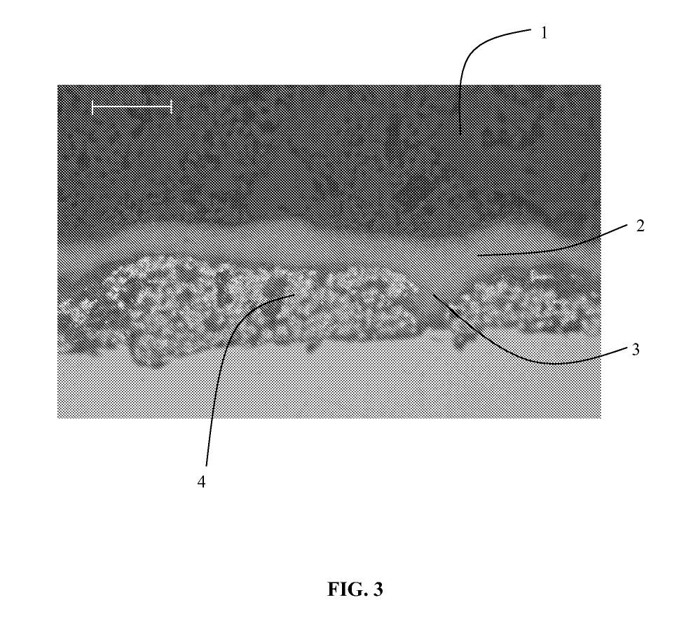

FIG. 3 shows a microphotogram of a cross section of a high strength steel substrate 1 coated by a sacrificial overlay of SermeTel W, item 4. A silicone resin-based high temperature paint is used as a seal coat, and is shown as penetrating void space 2 and filling gap 3, in order to prevent intrusion of corrosive aqueous fluids. The scale bar shown as a white line represents 1 mil (0.001 inch) length.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” used in connection with a quantity is inclusive of the stated value and has the meaning dictated by the context (for example, includes the degree of error associated with the measurement of the particular quantity). “Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present. The singular forms “a”, “an” and “the” include plural referents unless the context clearly dictates otherwise. All ranges disclosed herein are inclusive of the recited endpoint and independently combinable.

As used herein, the phrases “adapted to,” “configured to,” and the like refer to elements that are sized, arranged or manufactured to form a specified structure or to achieve a specified result. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. It is also anticipated that advances in science and technology will make equivalents and substitutions possible that are not now contemplated by reason of the imprecision of language and these variations should also be construed where possible to be covered by the appended claims.

What is claimed as new and desired to be protected by Letters Patent of the United States is:

1. A method for inhibiting stress corrosion cracking or surface pitting of a turbine component subject to rotary stress, the method comprising:
providing a turbine component comprising a high strength steel;
applying a sacrificial overlay coating material to at least a portion of a surface of the component to form a protected component; and
applying a seal material to at least a portion of the protected component to form a seal coat having a temperature resistance of greater than about 500° F.;
whereby the method is capable of inhibiting at least one of stress corrosion cracking or surface pitting of the turbine component after exposure to corrosive water.

2. The method in accordance with claim 1, wherein applying a sacrificial overlay coating material includes forming a substantially electrically conductive sacrificial coat.

3. The method in accordance with claim 1, wherein the sacrificial overlay coating material includes metallic particles of one or more selected from the group consisting of aluminum, zinc, cadmium, magnesium, and alloys of any of the foregoing metal.

4. The method in accordance with claim 1, wherein applying a sacrificial overlay coating material includes a step of applying an aqueous slurry comprising metallic particles and at least one of phosphate, molybdate, vanadate, tungstate, or chromate.

5. The method in accordance with claim 1, wherein the protected component is not burnished prior to applying the seal material.

6. The method in accordance with claim 1, wherein the protected component comprises pores, and wherein applying a seal material includes penetration of the seal material into at least some of the pores of the protected component.

7. The method in accordance with claim 1, wherein applying a seal material includes one or more application of the seal material to a surface of the protected component.

8. The method in accordance with claim 7, wherein applying a seal material further includes a step of curing after the one or more application of the seal material, and wherein the seal coat, after curing, is substantially non-porous.

9. The method in accordance with claim 1, wherein the seal material is applied by an application method selected from the group consisting of brushing, roiling, dipping, injecting, spraying, spin-coating, flow-coating, knife-coating, sprinkling, and combinations thereof.

10. The method in accordance with claim 1, wherein the seal coat has a temperature resistance of greater than about 700° F.

11. The method in accordance with claim 1, wherein the seal material comprises a binder selected from one or more of a silicone, a phosphate, a fluorinated polymer, or silicon, and further comprises a pigment selected from one or more of metallic particles, spinels, carbon particles, silica, siliceous materials, metal silicates, metal hydroxides, and metal oxides.

12. The method in accordance with claim 1, wherein the turbine component comprises an ultra-high strength steel.

13. The method in accordance with claim 1, wherein the turbine component comprises a steel selected from Marage 250, GE1014, and GE1010.

14. The method in accordance with claim 1, wherein the turbine component comprises a high strength steel having a yield strength of at least about 1380 MPa.

15. The method in accordance with claim 1, wherein said corrosive water comprises sea salt or a carboxylic acid.

16. The method in accordance with claim 1, wherein the turbine component is coupled in a gas turbine engine.

17. The method in accordance with claim 1, wherein the turbine component comprises a shaft, and wherein the shaft is coupled in a gas turbine engine selected from high bypass gas turbine engine and turbofan engine.

18. The method in accordance with claim 17, wherein the shaft is a fan mid shaft component of a shaft assembly extending between a fan assembly of the gas turbine engine and a low pressure turbine of the engine for transmission of torque therebetween in operation of the gas turbine engine.

19. A method for inhibiting stress corrosion cracking or surface pitting of a gas turbine engine component subject to rotary stress, the method comprising:
providing a turbine component comprising high strength steel having a yield strength of at least about 1380 MPa, wherein the turbine component is a fan mid shaft coupled in a turbofan engine;
applying a sacrificial overlay coating material to at least a portion of a surface of the component to form a protected component; and
applying a seal material to at least a portion of the protected component to penetrate seal material into at least some pores of the protected component and form a seal coat having a temperature resistance of greater than about 500° F.
whereby the method is capable of inhibiting at least one of stress corrosion cracking or surface pitting of the fan mid shaft after exposure to corrosive water.

20. A method for repairing a high-strength steel component of a turbofan engine, comprising,
inspecting the component;
applying a sacrificial overlay coating material to at least a portion of a surface of the component to form a protected component; and
applying a seal material to at least a portion of the protected component to form a seal coat having a temperature resistance of greater than about 500° F.
whereby the method is capable imparting inhibition to at least one of stress corrosion cracking or surface pitting of the component after exposure to corrosive water.

21. The method in accordance with claim 20, wherein the component is selected from fan mid shaft and coupling nut of a shaft assembly.

22. The method in accordance with claim 20, wherein inspecting the component comprises one or more inspection step selected from eddy current inspection, etching, visual inspection, magnetic particle inspection, hardness checking, dye penetration inspection, or ultrasound inspection.

23. The method in accordance with claim 20, further comprising removing a damaged portion from a surface of the component prior to applying the sacrificial overlay coating material.

24. The method in accordance with claim 1, wherein the seal material comprises one or more of metallic particles, spinels, carbon particles, silica, siliceous materials, metal silicates, metal hydroxides, and metal oxides.
